(19) United States
(12) Patent Application Publication
(10) Pub. No.: US 2014/0372769 A1
(43) Pub. Date: Dec. 18, 2014

(54) Automatic Protocol Selection in Mixed-Protocol Secure Computation

(71) Applicants: Florian Kerschbaum, Karlsruhe (DE); Axel Schroepfer, Rheinstetten (DE)

(72) Inventors: Florian Kerschbaum, Karlsruhe (DE); Axel Schroepfer, Rheinstetten (DE)

(73) Assignee: SAP AG, Walldorf (DE)

(21) Appl. No.: 13/920,937

(22) Filed: Jun. 18, 2013

(51) Int. Cl. G06F 21/71

(52) U.S. Cl. CPC G06F 21/71
USPC 713/189

(57) ABSTRACT

Secure multi-party computation may be performed utilizing mixed protocols in order to improve performance. In particular, embodiments implementing mixed protocols can reduce run time and thereby lower the cost of performing secure computation. Algorithms for optimizing selection from mixed protocols are disclosed, including an algorithm based on integer programming or an efficient heuristic algorithm for the selection problem. According to certain embodiments a selection engine is configured to receive as inputs, a function description and cost parameter(s). Based upon execution of the integer programming algorithm and the application of heuristics, the selection engine is configured to generate an output comprising a single cryptographic protocol (e.g. garbled circuit or homomorphic encryption). By employing mixed protocol selection according to embodiments, a compiler responsible for implementing secure computations can identify and select the fastest underlying mixed cryptographic protocols.

### BACKGROUND

Embodiments of the present invention relate to secure computation, and in particular, to automatic protocol selection in mixed-protocol secure computation.

Unless otherwise indicated herein, the approaches described in this section are not prior art to the claims in this application and are not admitted to be prior art by inclusion in this section.

Secure two-party computation allows two parties to compute a function ƒ over their joint, private inputs x and y, respectively without revealing their private inputs or relying on a trusted third party. Afterwards, no party can infer anything about the other party's input except what can be inferred from her own input and the output ƒ(x; y).

Secure computation has many applications, e.g., in the financial sector, and has been successfully deployed in commercial and industrial settings. However, performance may still be an issue in adoption of secure computation, even in the widely used semi-honest security model.

Accordingly, the present disclosure addresses these and other issues with automatic protocol selection in mixed-protocol secure computation.

### SUMMARY

Secure multi-party computation may be performed utilizing mixed protocols in order to improve performance. In particular, embodiments implementing mixed protocols can reduce run time and thereby lower the cost of performing secure computation. Algorithms for optimizing selection from mixed protocols are disclosed, including an algorithm based on integer programming and an efficient heuristic algorithm for the selection problem. According to certain embodiments a selection engine is configured to receive as inputs, a function description and cost parameter(s). Based upon execution of the integer programming algorithm or the application of heuristics, the selection engine is configured to generate an output comprising a single cryptographic protocol (e.g. garbled circuit or homomorphic encryption). By employing mixed protocol selection according to embodiments, a compiler responsible for implementing secure computations can identify and select the fastest underlying mixed cryptographic protocols.

An embodiment of a computer-implemented method comprises providing a compiler including a protocol selection engine and a cost model, causing the protocol selection engine to receive a function description comprising a plurality of operations, and applying an optimization algorithm to calculate from the cost model, a cost of converting an operation to an operation encrypted according to a first protocol or a second protocol. The protocol selection engine is caused to create an encrypted function according to the first protocol or according to the second protocol, depending on the cost.

An embodiment of a non-transitory computer readable storage medium embodies a computer program for performing a method comprising providing a compiler including a protocol selection engine and a cost model, causing the protocol selection engine to receive a function description comprising a plurality of operations, and applying an optimization algorithm to calculate from the cost model, a cost of converting an operation to an operation encrypted according to a first protocol or a second protocol. The method further comprises causing the protocol selection engine to create an encrypted function according to the first protocol or according to the second protocol, depending on the cost.

An embodiment of a computer system comprises one or more processors and a software program executable on said computer system. The software program is configured to provide a compiler including a protocol selection engine and a cost model, to cause the protocol selection engine to receive a function description comprising a plurality of operations, and to apply an optimization algorithm to calculate from the cost model, a cost of converting an operation to an operation encrypted according to a first protocol or a second protocol. The software program is further configured to cause the protocol selection engine to create an encrypted function according to the first protocol or according to the second protocol, depending on the cost.

Certain embodiments may further comprise causing the compiler to provide the encrypted function for secure multi-party computation in a semi-honest model.

In some embodiments the optimization algorithm comprises a heuristic algorithm.

According to particular embodiments the optimization algorithm comprises an integer programming algorithm.

In various embodiments the first protocol comprises a garbled circuits protocol.

According to some embodiments the second protocol comprises a homomorphic encryption protocol.

The following detailed description and accompanying drawings provide a better understanding of the nature and advantages of particular embodiments.

### BRIEF DESCRIPTION OF THE DRAWINGS

FIG. 1 shows a simplified view of an apparatus configured to perform automatic protocol selection in a mixed-protocol secure computation.

FIG. 1A is a simplified flow diagram showing a method according to an embodiment.

FIG. 2 shows an algorithm for cost-driven heuristic.

FIG. 3 shows runtime forecast values in seconds for a number of algorithms.

FIGS. 4A-4D show partitioning of algorithms in several use cases.

FIG. 5 shows metrics and values of partitionings for a number of algorithms.

FIG. 6 shows operators and their protocol assignment by partitioning for a number of algorithms.

FIG. 7 illustrates hardware of a special purpose computing machine configured to perform secure processing according to an embodiment.

FIG. 8 illustrates an example of a computer system.

### DETAILED DESCRIPTION

Described herein are techniques for automatic protocol selection in mixed-protocol secure computation. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Secure multi-party computation may be performed utilizing mixed protocols in order to improve performance. In particular, embodiments implementing mixed protocols can reduce run time and thereby lower the cost of performing secure computation. Algorithms for optimizing selection from mixed protocols are disclosed, including an algorithm based on integer programming or an efficient heuristic algorithm for the selection problem. According to certain embodiments a selection engine is configured to receive as inputs, a function description and cost parameter(s). Based upon execution of the integer programming algorithm and the application of heuristics, the selection engine is configured to generate an output comprising a single cryptographic protocol (e.g. garbled circuit or homomorphic encryption). By employing mixed protocol selection according to embodiments, a compiler responsible for implementing secure computations can identify and select the fastest underlying mixed cryptographic protocols.

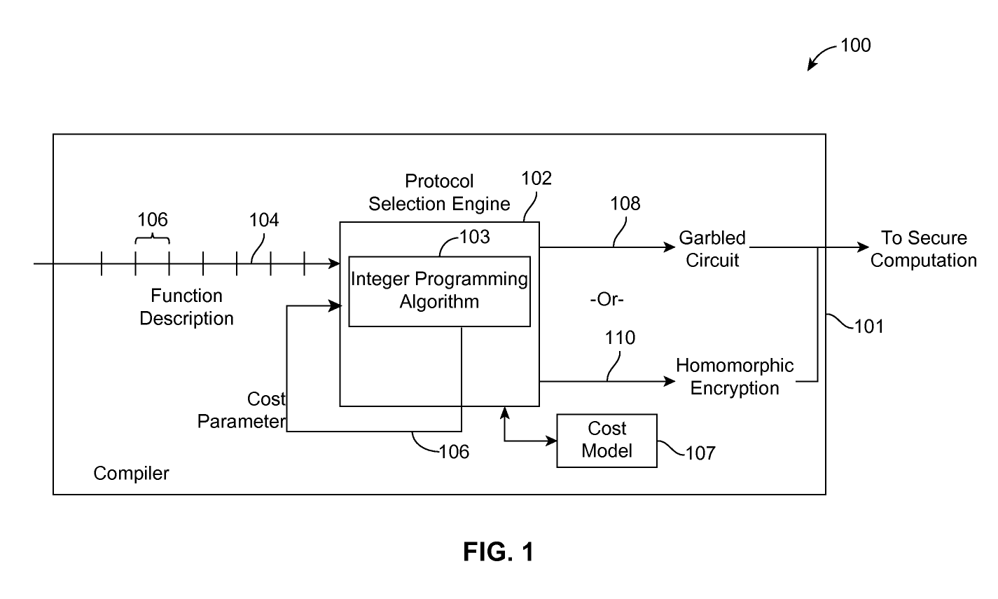

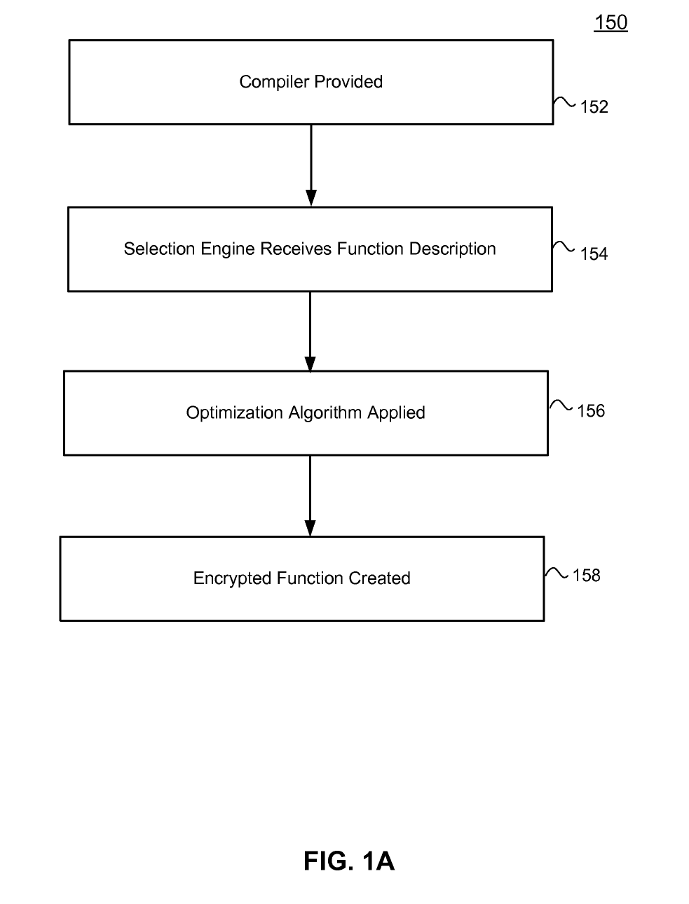

FIG. 1 shows a simplified view of an apparatus configured to perform automatic protocol selection in a mixed-protocol secure computation. In particular, the apparatus comprises a compiler 100 which includes a protocol selection engine 102.

The selection engine is configured to receive as input, a function description 104. The function description comprises a plurality of operations 106.

Based upon this input, the selection engine is configured to identify and select the fastest of the underlying protocols. This may be done by the application of an optimization algorithm.

The optimization algorithm 103 may comprise integer programming. The integer programming applies an objective function to each operation, and produces each of the operations of the function description executed as a respective garbled circuit.

An optimization algorithm 103 may apply heuristics. In particular, each of the operations as a garbled circuit is consecutively scanned in a loop to be converted to homomorphic encryption. The optimization algorithm references a cost model 107, and a cost of that conversion is determined.

If the cost decreases when converting the operation to homomorphic encryption, the conversion is performed. Otherwise, the conversion is not performed.

The scanning of each operation of the function description is repeated, until no more operations are converted to homomorphic encryption due to cost considerations.

Based upon application of the optimization algorithm 103, the protocol selection engine produces an output comprising an encrypted function 108 according to the garbled circuit protocol, or an encrypted function 110 according to the homomorphic encryption protocol.

FIG. 1A is a simplified flow diagram showing a method 150 according to an embodiment. In a first step 152, a compiler including a protocol selection engine and a cost model is provided. In a second step 154, the protocol selection engine is caused to receive a function description comprising a plurality of operations. In a third step 156, an optimization algorithm is applied to calculate from the cost model, a cost of converting an operation to an operation encrypted according to a first protocol or a second protocol. In a fourth step 158 the protocol selection engine is caused to create an encrypted function according to the first protocol or according to the second protocol, depending on the cost.

Thus rather than relying on a single protocol to perform secure computation, as described herein various embodiments may mix protocols. Then, based on an extended performance model, an optimal protocol for a sub-operation is automatically selected. At least two algorithms for the protocol selection problem are possible:

an optimization based on integer programming;

a heuristic algorithm.

As discussed below, these are applied to the following use cases from the literature: secure joint economic lotsize, biometric identification, and data mining.

Then, the evaluation of the implementation of these algorithms in an intermediate language are used to test to test the following three (3) hypotheses.

1) Embodiments employing mixed protocols are faster than a pure garbled circuit implementation.
(2) Close results are obtained utilizing the heuristic algorithm and using the optimum-found-by-integer-programming algorithm.
(3) The protocol selection problem is too complicated to be solved manually by the programmer.

A heuristic according to an embodiment can be used in a compiler to automatically select the fastest sub-protocols in secure computations. In this way, a selection algorithms can be used to automatically select mixed protocols with near-optimal performance.

1.1 Secure Computation Protocols

Embodiments may integrate two protocols for performing secure two-party computations: garbled circuits and homomorphic encryption. Both protocols are generic (i.e. they can securely implement any ideal functionality). Nevertheless these secure computation protocols have different performance characteristic

As used herein, two parties Alice A and Bob B are named. The following explains these two basic protocols, gives conversions that allow to combining and automatically selecting between both protocols, and gives background on the underlying semi-honest security model.

1.1.1 Garbled Circuits

Garbled circuits were the first generic protocol for secure two-party computation. A high-level overview without the technical details of encryption is now provided.

The garbled circuits protocol allows secure computation of an arbitrary ideal functionality that is represented as a Boolean circuit C. The basic idea is that C is evaluated on symmetric keys where one key corresponds to the plain value 0 and another to the plain value 1. Alice creates for each gate of C an encrypted table such that given the gate's input keys only the corresponding output key can be decrypted. Then, Alice sends to Bob the keys for the input wires of C in an oblivious manner. For each of Bob's inputs, both parties run a 1-out-of-2 oblivious transfer (OT) protocol. The OT protocol ensures that Bob obtains only the key corresponding to his input whereas Alice does not learn Bob's input. Now, Bob can use the encrypted tables to evaluate C under encryption. Finally, Bob sends the keys that correspond to Alice's outputs back to Alice. For his outputs, he is given a mapping that allows him to decrypt the output keys into plain output values.

For the garbled circuits protocol, efficient techniques and instantiations are implemented. For OT extensive use is made of the technique of extending OTs using symmetric cryptography, using the efficient OT protocol for the small number of base OTs. For garbled circuits, the optimizations for free XOR gates, garbled row reduction, and pipelining are used. These protocols and constructions are proven secure against semi-honest adversaries based on the random oracle and computational Diffie-Hellman assumptions.

1.1.2 Homomorphic Encryption

Secure computation can also be implemented based on additively homomorphic encryption. On the one hand, opposed to fully homomorphic encryption, additively homomorphic encryption only implements addition (modulo a key-dependent constant) as the homomorphic operation. On the other hand, additively homomorphic encryption is almost as fast as standard public-key cryptography, whereas the practicality of fully homomorphic encryption schemes is subject to research.

Let E_{X}(x) denote the encryption of plaintext x encrypted under Xs (Alice's or Bob's) public key and D_{X}(c) the corresponding decryption of ciphertext c. Then the additive homomorphism can be expressed as

D_{X}(E_{X}(x)·E_{X}(y))=x+y.

Multiplication with a constant c can easily be derived as

D_{X}(E_{X}(x)^{c})=cx

Secure computation of an arbitrary functionality represented as arithmetic circuit can be built from homomorphic encryption as follows. Each variable is secretly shared between Alice and Bob. Let x be a variable of bit length l. Then Alice has share x_{A} and Bob has share x_{B}, such that

x=x_{A}+x_{B} mod 2^{l}.

In order to securely implement the ideal functionality it suffices to securely implement addition and multiplication of shares. Addition of x=_{A}+x_{B} and y=y_{A}+y_{B} (of the same bit-length l) can be implemented locally by addition of each party's shares. Multiplication z=x·y needs to be implemented as a protocol. Let σ be the statistical security parameter in the share conversion protocol. Let r be a uniformly random number of bit length 2l+σ+1. The following protocol is used for secure multiplication of shares:

A→B E_{A}(x_{A}), E_{A}(y_{A})

B→A E_{A}(c)=E_{A}(x_{A})^{yB}E_{A}(y_{A})^{TB}E_{A}(r)

A z_{A}=x_{A}y_{A}+c mod 2^{l}

B z_{B}=x_{B}y_{B}−r mod 2^{l}.

It is easy to verify that z_{A}+z_{B}=(x_{A}+x_{B})(y_{A}+y_{B}) mod 2^{l}. Also other operations can be implemented using homomorphic encryption as described later in Section 1.2.1.

The implementation uses Paillier's cryptosystem which is secure against chosen plaintext attacks (IND-CPA) under the decisional composite residuosity assumption.

1.1.3 Conversion

The following describes how secure computations based on garbled circuits and homomorphic encryption can be combined by converting from one representation of intermediate values to the other. The methods used for these conversions are similar to previous works, but are more efficient as they use the shorter random masks.

Homomorphic Encryption to Garbled Circuits is now described. Assume that what is wanted is to compute a sub-functionality ƒ using garbled circuits where one of the l-bit inputs x has been computed using homomorphic encryption, i.e., x is represented as shares x_{A} and x_{B} with x=x_{A}+x_{B} mod 2^{l}.

To use x as input for the garbled circuit, extend the inputs of the garbled circuit computing ƒ with an l-bit addition circuit to which A provides input x_{A} and B provides input x_{B}, i.e., the slightly larger garbled circuit computes ƒ( . . . , x_{A}+x_{B} mod 2^{l}, . . . ). Note that reduction modulo 2^{l} is easily obtained by dropping the most significant carry bit.

Garbled Circuits to Homomorphic Encryption is described as follows. Similarly, it is possible to convert the output z of a sub-functionality that has been computed using garbled circuits into secret shares z_{A}; z_{B} that can later on be used for secure computations using homomorphic encryption.

For this, extend the output of the garbled circuit with an l-bit subtraction circuit whose subtrahend is a randomly chosen l-bit value z_{A} provided by A. Then modify the garbled circuit protocol such that only B obtains the output z_{B}=z−z_{A}, i.e., he does not send the output keys back to A.

Optimization may be achieved as follows. Note that it is only necessary to convert the inputs and outputs of operations that are securely computed with a different protocol type. Furthermore, each variable can be converted at most once and then can be used as input to all sub-functionalities.

1.1.4 Security

All protocols described in this section—garbled circuits, homomorphic encryption, and mixed protocols—are secure in the semi-honest model. In this model participants follow the protocol as prescribed, but keep a record of the messages received and try to infer as much information as possible about the other party's input. Protocols secure in the semi-honest model ensure that an adversary cannot infer any information beyond what he can infer from its input and output of the protocol. This model covers many real-life threats such as attacks by honest but curious insiders. Proofs of security in the semi-honest model generally follow the simulation paradigm by constructing a simulator that simulates all messages given only the inputs and output of a party. A protocol is said to be secure in the semi-honest model if the simulator's output is computationally indistinguishable from a real protocol execution.

For garbled circuits a proof of security is found. Proofs for the protocols using homomorphic encryption are known. For security of the mixed protocol, Goldreich's composition theorem is referred to.

1.2 Cost Model

In order to choose which operation to implement using which protocol, it is necessary to compare their costs. Cost refers to the (wall clock) run-time of the protocol. Since the protocol can be composed from sub-protocols of both protocol types—garbled circuits and homomorphic encryption—it is necessary to assess their performance while taking care of additional conversion costs. The cost model is based on a model which can (reasonably) reliably forecast the protocol run-time for both types of protocols. The accuracy of the forecast mainly determines the effectiveness of this approach.

The following summarizes the layers of the cost model in Section 1.2.1, extend it to cover today's most efficient instantiations for garbled circuits in Section 1.2.2, and give the costs for conversions in Section 1.2.3.

1.2.1 Layers

The cost model is divided into four layers. The top three layers are parameterized by the implemented algorithm and security parameters. The lowest layer is parameterized by the performance of the actual systems on which the protocols are deployed. This performance is measured for some basic operations once. Then, different protocols can be compiled. Alternatively, pre-configured costs for representative environments can be chosen by the programmer.

The first layer captures the number of input and output variables of every player, as well as the bit-length of these variables. The second layer captures the algorithm as a sequential list O of operations. An operation o={\vec{l}, o, \vec{r}}εO comprises an assigned variable, a left-operand, an operator and a right-operand (3-operand code). Assignments are single static assignments. An intermediate language is adopted for selection algorithms.

The intermediate language currently supports the following operations for which secure protocols are given. Some of these operations leverage the specific advantages of the respective protocol type, i.e., direct access to single bits and shift operations for garbled circuits or arithmetic operations for homomorphic encryption.

addition ⊕

subtraction ⊖

dot product ⊙ₑ

multiplication by a constant ⊙ₑ

division by a constant Ø_{c}

left shift by a constant <<_{c}

right shift by a constant >>_{c}

less-or-equal ≦

All operands are scalars with the exception of dot product which handles vectors of e elements allowing for the concurrent multiplication of several variables. The third layer captures the protocol type and their security parameters, i.e., the lengths of keys in garbled circuits, homomorphic encryption, and oblivious transfer. The fourth layer captures the performance of systems and network, i.e., the times for performing local operations (e.g., a homomorphic encryption or a hash-function), and network bandwidth and latency.

Given these parameters, a run-time forecast (cost) of the protocol can be computed in the respective model. The cost computation can be implemented using arithmetic formulas, with an empirical evaluation showing that these formulas estimate the run-time within an error bound of less than 30%.

1.2.2 Improved Garbled Circuits

The performance model is extended and adapted to reflect today's most efficient methods for implementing garbled circuits protocol as used modern implementations. Free XORs, garbled row reduction, and pipelining are used for garbled circuits. For oblivious transfer (OT), the OT protocol using an online version is used. Using α^{A} and α^{B}, the number of input bits of Alice and Bob is denoted, and using β^{A} and β^{B}, their number of private output bits is denoted.

Optimized GC Construction is described as follows. Let k_{GC} be the length of symmetric keys used in the garbled circuit construction. Using the free XOR technique, a random key of length k_{GC} needs to be chosen for the key difference and each input bit of A and B. Using the garbled row reduction technique, the random keys for the outputs of the binary gates are determined given the random keys of the inputs and no longer need to be chosen at random. Let t_{RND}^{A}(n) be the time to choose n random bits by Alice. Then, the overall time to choose the random keys is reduced to approximately:

t_{rand}=(1+α^{A}+α^{B})t_{RND}^{A}(k_{GC}).

Due to the free XOR technique that requires only negligible computation and no communication for XOR gates, n_{g} is set to the number of non-XOR gates (in the original model this was the total number of gates). For the basic operations, circuits are used that are optimized to have a small number of non-XOR gates: n_{g}(⊕)=n_{g}(⊖)=n_{g}(≦)=l, where l is the bit length of the operands. Similarly, n_{g}(⊙ₑ)=(2l²−l+4)e and n_{g}(⊙ₑ)=l(d_{H}(c)−1), where d_{H}(c) is the Hamming weight of c, are used.

The garbled row reduction technique of results in only 3 encrypted table entries per non-XOR gate, i.e., approximately 3k_{GC} bits. Let t_{msg}(s) denote the time required for transferring a message of size s bits, i.e., t_{msg}(s)=s/rₜ_{_{LAT}}_{,b}(s) where rₜ_{_{LAT}}_{,b}(n) is the transfer rate for sending n bits (depending on bandwidth b and latency t_{LAT}). Furthermore, let t_{OWH}^{A} and t_{OWH}^{B} denote the time for computing the one-way hash function used for symmetric encryption of a garbled circuit gate entry by Alice and Bob, respectively. Fast implementation of garbled circuits is based on a pipelining approach, i.e., for each gate the encrypted table entries are generated by Alice, sent directly to Bob, and evaluated by Bob. Hence, the total time for streaming, i.e., generating, transferring, and evaluating, the garbled circuit can be approximated by t_{GC}=n_{g} max(4t_{OWH}^{A}(2k_{GC}), t_{msg}(3k_{GC}), t_{OWH}^{B}(2k_{GC})).

The overall time (cost) for the entire garbled circuit protocol as implemented is the sum of the times for:

choosing random wire labels t_{rand},

sending the wire labels for A's inputs t_{msg}(α^{A}k_{GC})

sending the wire labels for B's inputs via OT t_{OT}(α^{B})

streaming the garbled circuit t_{GC},

sending A's encrypted outputs t_{msg}(β^{A}k_{GC}), and

sending the output decryption information for B's outputs t_{msg}(2β^{B}k_{GC}).

1.2.3 Conversion Costs

The model actually distinguishes the two protocol types. It is necessary to now additionally estimate the conversion costs between the two protocols.

Recall that all operations in the intermediate language are represented in 3-operand code (cf. Section 1.2.1). Let a=b·c be such a 3-operand operation. As each variable is assigned exactly once (single static assignment), the assigned variable a can be used as a short notation for the operation. There are two cases when it is necessary to consider conversion costs according to the conversions described in Section 1.1.3. If a is implemented using homomorphic encryption, but b (or c) is implemented using garbled circuits, then b (or c) needs to be converted from their garbled circuit representation into secret shares by adding an input for Bob's random share z_{B} and extending the garbled circuit with a subtraction circuit. If a is implemented using garbled circuits, but b (or c) is implemented using homomorphic encryption, then b (or c) needs to be converted from their representation as secret shares into inputs for the garbled circuit by adding an addition circuit and inputs for the shares. Again, it is important to note that each operand needs to be converted at most once in the entire mixed protocol.

It is then possible to compute the cost of the mixed protocol as the sum of its parts. For the costs of each part implemented as either protocol type, use the formulas for homomorphic encryption, the improved formula described in Section 1.2.2 for garbled circuits, and the conversion costs described above.

2. Optimal Partitioning

Given the cost model described in Section 1.3, the problem of an optimal partitioning of the operations into the protocol types can be described in this way. Consider a compiler that translates a programming language into the intermediate language described in Section 1.2.1. In order to construct a cost-optimal (i.e., the fastest) protocol it needs to assign each operation of the intermediate language a protocol type, also considering the conversion costs.

The problem formulation is set up as follows. Let the elements xᵢ correspond to the left hand-side variable assigned in an operation. Denote with [symbol] the set of these elements (variables). The operator mapping function op maps xᵢ to the right hand-side operators of that operation. The cost function a(xᵢ) corresponds to the costs for computing x, using garbled circuits and b(xᵢ) to the costs using homomorphic encryption, respectively. The cost functions c(xᵢ) and d(xᵢ) correspond to the costs for converting xᵢ from homomorphic encryption to garbled circuits and vice-versa, respectively. The set [symbol] ⊂ [symbol] of instructions will be implemented using garbled circuits; the set [symbol] \ [symbol] using homomorphic encryption. The problem is formally defined as follows:

Let there be a set [symbol] of elements x₁, . . . , xₙ. Let there be a function op(xᵢ) mapping xᵢ to a set [symbol] ᵢ⊂ [symbol] . Let there be four cost functions a(xᵢ), b(xᵢ), c(xᵢ), and d(xᵢ). Find the subset [symbol] ⊂ [symbol] that optimizes the following cost function:

Σ_{(x|xε} [symbol] ₎a(x)+Σ_{(x|xε} [symbol] _{\} [symbol] ₎b₍x)+

Σ_{(x|xε} [symbol] _{\} [symbol] _{,∃y,yε} [symbol] _{,xεop(y))}c(x)+

Σ_{(x|xε} [symbol] _{,∃y,yε} [symbol] _{\} [symbol] _{,xεop(y))}d(x).

There are some restrictions on the function op that are not captured in this problem definition. First, the set [symbol] ᵢ restricted to a size of at most 2 (three operand code). Second, the set [symbol] is ordered and op(xᵢ) may only include elements x_{i′} that have been computed already, i.e., i′<i. Nevertheless, if the general problem is solved, the restricted problem is solved.

A further complication is that the cost functions in the cost model do not only depend on the individual operation, but also on its neighbors. As such this already complex problem can only be seen as an approximation of the performance model. This is addressed in Section 2.1.

Partitioning problems, e.g., graph partitioning, are typically NP-hard, but unfortunately a hardness proof for this specific instance cannot be provided. First, the specific parameters for the maximum sizes of the partitions (almost the entire set) have not yet been proven NP-hard. Second, the restrictions on the function op(x) complicates the reduction. Nevertheless, it is conjectured that the problem is NP-hard.

2.1 Integer Programming

The best solution to the partitioning problem defined above is sought using an optimization algorithm. However, due to the size of the problem (the largest example considered in Section 3 has 383 operations) an exhaustive search is prohibitive, such that a more efficient approach for optimization is needed. 0, 1-integer programming is a suitable candidate, but some non-linear costs must be accounted for.

In 0, 1 integer programming there are variables \vec{z} for which an assignment is sought which minimizes a linear objective function c(z)^{T}\vec{z} subject to certain constraints. In its standard form it is represented as

$$min {\vec{c}}^{T} \vec{z}$$

$$A \vec{ z} \leq \vec{b}$$

$$z ∈ \vec{\{ 0 , 1 \}} .$$

For each element xᵢ in the set of variables [symbol] the following three variables are added to the integer program:

zᵢ′ε{0, 1} indicates whether the operation assigning xᵢ will be executed using homomorphic encryption (0) or garbled circuits (1).
zᵢ″ε{0, 1} indicates whether the variable xᵢ needs to be converted from homomorphic encryption to garbled circuits.
zᵢ′″ε{0, 1} indicates whether the variable xᵢ needs to be converted from garbled circuits to homomorphic encryption.

An element xᵢ is either implemented as garbled circuits or homomorphic encryption. So one variable suffices, but for conversion two variables are needed. An element might not be converted at all, although it is never converted in both directions.

The objective function to be minimized follows directly from this construction:

$$min ( {\sum }_{i} a ( {x}_{i} ) {z}_{i}^{′} - {\sum }_{i} b ( {x}_{i} ) {z}_{i}^{′} + {\sum }_{i} c ( {x}_{i} ) {z}_{i}^{″} + {\sum }_{i} d ( {x}_{i} ) {z}_{i}^{′′′} )$$

One complication of this objective function is the non-linearity of garbled circuit execution time. Side effects on OS and hardware level (like JIT compilation, CPU caching, etc.) lead to non-linear costs per gate if the number of gates is below a certain threshold. These effects have an influence on the cost objective of the integer program. Sums of costs for single garbled circuits of adjacent operations of the SSA algorithm are likely (due to their small size) to be higher than costs of a garbled circuit of combined operations (exceeding the threshold).

The method to incorporate a correction in the objective function is to add different (decreasing) costs for a respective operation xᵢ, depending on whether the previous operations i′<i have been computed using garbled circuits (z_{i′}=1). In order to limit the number of additional variables in the integer program, at most k=20 previous operations are considered. Let aⱼ(xᵢ) (a₀(xᵢ)> . . . >aₖ(xᵢ)) be the cost of an operation xᵢ if it and the previous j(0≦j≦k) consecutive operations are executed as garbled circuits. Next, the new variables z_{i,j}′ are introduced and each term a(xᵢ)zᵢ′ of operation i is replaced in the objective function by

a₀(xᵢ)z_{i,0}′+a₁(xᵢ)z_{i,1}′+ . . . +aₖ(xᵢ)z_{i,k}′.

A constraint is added to allow only one new variable z_{i,j}′ per operation to be set to 1 such that only its cost is added

z_{i,0}′+ . . . +z_{i,k}′−zᵢ′=0.

Then constraints are added for previous operations that are executed as garbled circuits in order to select the correct (minimal) j'th cost aⱼ(xᵢ)

z_{i,j}′−zᵢ₋₀′≦0

z_{i,j}′−zᵢ₋ⱼ′≦0

The following constraints implement the conditions for the conversions based on the operator mapping function op. For each operation (element) xᵢε [symbol] and each of its operands xⱼεop(xᵢ) the following constraint that determines whether xⱼ needs to be converted from garbled circuits to homomorphic encryption is added;

zᵢ′−zⱼ′−zⱼ″≦0,

i.e., if zᵢ′ is set (xᵢ is to be computed using garbled circuits), but zⱼ′ is not set (xⱼ was computed using homomorphic encryption), then zⱼ″ must be set (xⱼ must be converted).

Similarly, for each operation xᵢε [symbol] and each of its operands xⱼεop(xᵢ) the following constraint that determines whether xⱼ needs to be converted from homomorphic encryption to garbled circuits is added;

−zᵢ′+zⱼ′−zⱼ′″≦0,

i.e., if zᵢ′ is not set (xᵢ is to be computed using homomorphic encryption) and zⱼ′ is set (xⱼ was computed using garbled circuits), then zⱼ′″ must be set (xⱼ must be converted).

Let n= [symbol] be the number of operations. Then, this integer program has kn+4n variables and at most

$$\frac{k ( k - 1 \overline{)} n}{2} + 5 n$$

constraints.

2.2 Heuristic

Integer programming is NP-complete and can become very slow for large instances. Therefore, it is also possible to implement a heuristic optimization using a greedy algorithm. At the start, all operations are executed as garbled circuits. Then, each operation is consecutively scanned in a loop. If the overall cost decreases when converting this operation to homomorphic encryption, this is done. The process is repeated until no more operations are converted.

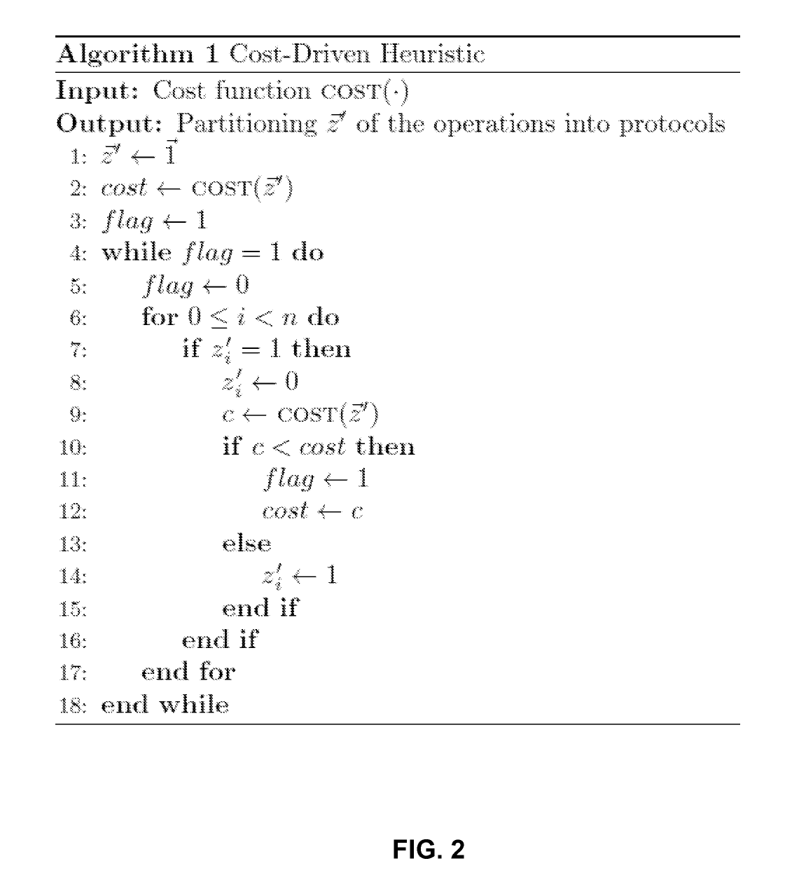

The heuristic algorithm is shown in FIG. 2. The same variables zᵢ′ as above in Section 2.1 are used for each operation representing its assignment to either protocol type. The variables zᵢ″ and zᵢ′″ can be inferred using a helper routine and the remainder of the cost function as COST also as above in Section 2.1 can be implemented. Initially all zᵢ′ is set to 1 for garbled circuits (line 1). The algorithm has worst-case complexity O(n²), since the inner loop (lines 6-17) is executed at most n times (at least one operation must be converted per iteration of the outer loop).

3. Use Cases

In order to validate the complexity of manual partitioning and the cost advantage of this algorithmic approach, three use cases for secure computation from the literature are considered: joint economic-lot-size in Section 3.1, biometric identification in Section 3.2, and data mining in Section 3.3. Afterwards, their performance is evaluated in Section 3.4.

3.1 Secure Joint Economic Lot-Size

The secure joint economic lot-size problem describes a two-party scenario between a vendor and a buyer of a product. Both try to align the process of production, shipping, and warehousing according to an overall buyer's demand. Specifically, they try to agree on a joint lot-size q for production and shipping. The lot-size directly influences one's own costs. Therefore, every party has an interest to agree on the joint lot-size that minimizes its costs. Both parties can perform better by agreeing on an optimal joint economic-lot-size q*. First, total costs (summed costs of both sides) become minimal in presence of q*. Using a side payment this minimal total optimum also minimizes one's own cost. However, calculating the joint economic lot-size requires sensitive inputs (such as costs and capacities) by both parties who will only take part in the computation if the confidentiality of their inputs is preserved. The confidentiality-preserving computation of q* can be reduced to secure division.

Secure division is also relevant for many other real world secure computations, e.g., k-means clustering. Various cryptographic protocols for secure two-party and multi-party division protocols have been proposed. They use different approaches for their algorithm implementation and cryptographic protocols. Straight-forward solutions implement division algorithms as circuits and use generic secure computation protocols in the two-party setting. Other protocols are specific to the problem and use individual shortcuts in order to achieve higher efficiency than general secure division protocols, using cryptographic tools like homomorphic encryption.

Again, other protocols try to improve the efficiency of generic solutions using alternative data representation, e.g., fixed-point values. With respect to algorithms for secure division, two well known algorithms have been used to result in a control flow that is independent of the input values. The Newton-Raphson method approximates the result in a fixed number of iterations and long division is an extension of the school method for division.

As the use case, both division algorithms—the Newton-Raphson variant and the long division variant—are considered. That is, it is computed for 32 bit inputs x and y held as shares x_{A}, y_{A} and x_{B}, y_{B} by the respective parties (cf. Section 1.1.2)

$$f ( {x}_{A} , {y}_{A} , {x}_{B} , {y}_{B} ) = \frac{{x}_{A} + {x}_{B}}{{y}_{A} + {y}_{B}} .$$

The Newton-Raphson implementation has 302 operations in the intermediate language, and the long division operation has 383 operations.

3.2 Biometric Identification

Comparing and matching biometric data is a highly privacy-sensitive task in systems that are widely used in law enforcement, including fingerprint-, iris-, and face-recognition systems. Technically, these systems consist of a server-side database that contains sets of previously recorded biometric information as well as associated personal records. In order to identify entities in the database, clients submit the collected biometric information to the server. The identification is based on comparing the submitted biometric information to values in the database, determining the closest match with respect to some metric (e.g., Euclidean distance).

Doing this sort of biometric identification in a privacy-preserving way allows to run the identification mechanism without revealing any information: neither is the client's collected biometric information disclosed to the server, nor is the server's data disclosed to the client beyond the information whether a closest match was found or not. The problem of biometric identification also arises in the context of face recognition, iris, or fingerprint matching.

These biometric identification systems contain two phases. A first distance computation phase calculates distances between the client's information (a vector of M samples) and the N entries (resp., their vectors) in the database. A second matching phase determines the ε-closest database entry, i.e., the entry that has the minimal distance in a maximum range ε comparing to the biometric information of the client.

As the use case, an algorithm for biometric identification, computing the distances using Euclidean distance as metric which is commonly used for fingerprints and faces, is considered. It is computed as follows:

$$min ( {\sum }_{i = 1}^{M} {( {S}_{1 , i} - {C}_{i} )}^{2} , … , {\sum }_{i = 1}^{M} {( {S}_{N , i} - {C}_{i} )}^{2} )$$

for N=5 vectors of M=4 elements S_{i,j} in the server database and a client vector Cᵢ of M elements, for elements of 32 bit. The algorithm has 80 operations in the intermediate language.

3.3 Data Mining

While many organizations have collected large volumes of data, its storage is rather useless if no “meaningful information” can be extracted from it. Data mining aims to extract knowledge from databases, connecting the worlds of databases, artificial intelligence, and statistics. Various data mining algorithm for different purposes have been proposed in the literature. One particular purpose is that of structuring data sets in order to provide decision mechanisms that can be used for classification. In a first decision tree learning phase, a training database is used in order to compute a decision tree based on attributes of contained transactions. In a second phase, the decision tree can be used to efficiently classify new transactions.

A well-known algorithm for decision tree learning is the ID3 algorithm. ID3 creates the decision tree top-down in a recursive fashion. At the root, each attribute of the transactions in the training set is tested and the one which “best” separates the set in classes is chosen. The set is then partitioned by this attribute and the step is applied recursively to all sub-sets until no more sets are left. The key operation of ID3 remains to select the best attribute in each step. Commonly, information-theoretic entropy based metrics are used to compute the best attribute.

A privacy-preserving classification variant of ID3—representing one of the first privacy-preserving data mining algorithms—allows new applications where multiple private databases can be used to act as training set (e.g., medical databases). Entropy is used to compute the best attributes, with the privacy-preserving computation of the natural logarithm as the basis operation.

As the use case, an algorithm to compute the natural logarithm—a first implementation of this privacy preserving data mining algorithm—is considered. That is, the natural logarithm of a 32 bit input x=2ⁿ (1+ε) is computed held as shares x_{A} and x_{B} by the respective parties where 2ⁿ is the power of 2 which is closest to x and −½≦ε≦½. The natural logarithm is approximated with a Taylor series with k=10 iterations:

$$ln ( x ) = ln ( {2}^{n} ( 1 + ε ) ) = n ln 2 + ε - \frac{{ε}^{2}}{2} + … \frac{{ε}^{k}}{k} .$$

The algorithm has 270 operations in the intermediate language.

3.4 Example/Evaluation

The following presents the evaluation results for optimal partitioning of secure computation protocols for the use cases introduced in Sections 3.1 to 3.3. Using these results a comparison is made between the performance of mixed protocols to garbled circuit protocols in Section 3.4.1, the optimization of the heuristic to that of integer programming in Section 3.4.2, and the automatic optimal partitioning to the manual approach in Section 3.4.3.

As execution environment of the secure computation protocols, consider a LAN environment (bandwidth b=100 Mbit/s, latency t_{LAT}=0 ms) and a WAN environment (bandwidth b=1 Mbit/s, latency t_{LAT}=100 ms). The performance of local operations has been measured on servers hosting four AMD Opteron 885 dual-core 64-bit CPUs and 16 GB RAM using a single-threaded implementation. Java Version 6 is used. With respect to the cryptographic parameters, the recommendations by NIST are followed:

short-term security (recommended until 2010): size of RSA modulus in the homomorphic cryptosystem k_{HE}=|p|=1.024, garbled circuit key-length k_{GC}=80 and |q|=160 (using SHA-1 as OWH function);

mid-term security (recommended 2011-2030): size of RSA modulus in the homomorphic cryptosystem k_{HE}=|p|=2.048, garbled circuit key-length k_{GC}=112 and |q|=224 (using SHA-224 as OWH function);

long-term security (recommended [symbol] 2030): size of RSA modulus in the homomorphic cryptosystem k_{HE}=|p|=3.072, garbled circuit key-length k_{GC}=128 and |q|=256 (using SHA-256 as OWH function).

In a brief experimental study, the accuracy of the performance model described in Section 1.3 was confirmed. All four use cases were executed in the LAN/WAN setting with short-term security using the mixed partitioning. The forecasts were always within a 30% error bound.

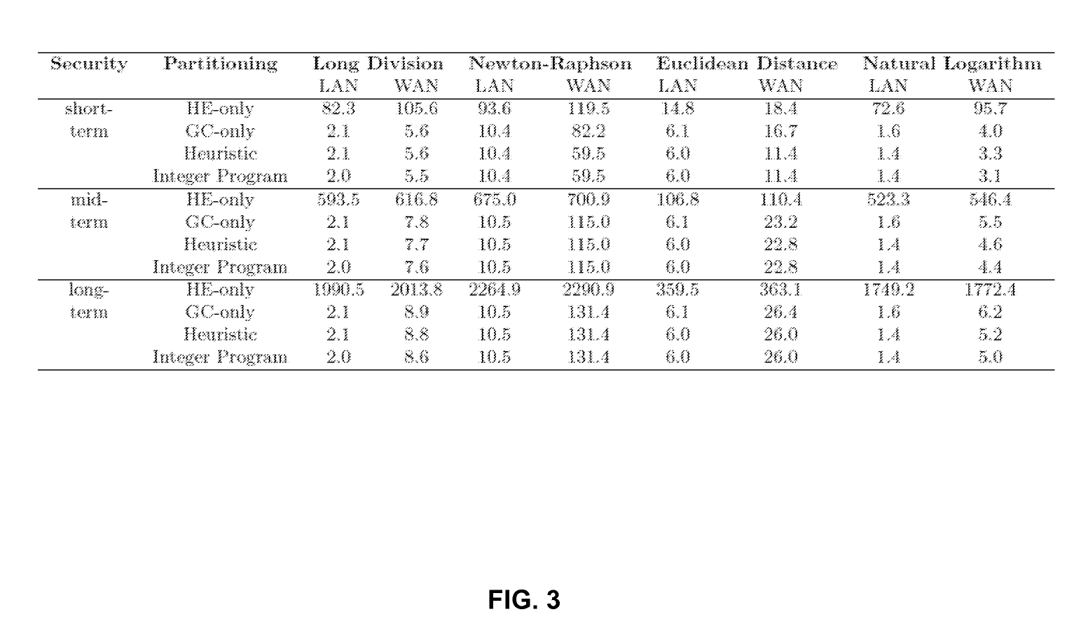

FIG. 3 summarizes the runtime forecasts for algorithms long division, Newton-Raphson, Euclidean distance, and natural logarithm. The table comprises the respective results in seconds for partitions that are computed entirely using homomorphic encryption (HE-only) or garbled circuits (GC-only), and for mixed partitions that were found by heuristic and by integer programming

3.4.1 Mixed Versus Non-Mixed Protocols

The results in FIG. 3 show that for the use cases, mixed protocols can reduce runtimes below those of single protocol types. For pure homomorphic encryption and garbled circuits, two conclusions can be drawn. First, in all use cases and settings the homomorphic encryption protocols result in highest runtimes. In particular for growing key lengths of mid- and long-term security settings, homomorphic encryption is slower than garbled circuits by orders of magnitudes.

Second, garbled circuit protocols are sometimes competitive, but may be improved by mixed protocols. In 16 out of 24 experimental settings, garbled circuits have runtimes close to the best results (not more than 5% deviation). In four cases the garbled circuit protocol results in the best performance. In all experimental settings, both partitioning mechanisms for computing optimal mixed protocols result in the best performance, including the previously mentioned four pure garbled circuit cases. In 8 of 24 settings, the mixed protocols result in an average of 20% less runtime. The largest improvement is 32% lower runtime compared to the protocol entirely implemented as garbled circuit (Euclidean distance, short-term security, WAN).

It can be inferred that network conditions are essential in the context of performance measurements. For LAN settings, mixed protocols obtain on average an improvement over the garbled circuit protocol of 4%. For WAN settings, however, the improvement is significantly higher, namely 11%.

3.4.2 Heuristic Versus Integer Programming

Both optimization approaches result in mixed protocols that perform, in almost half of all experimental settings, noticeably better than pure protocols. As seen from the results in FIG. 3, the heuristic based partitioning results are close to those of integer programming (deviating not more than 2.7% on average, at maximum 7.6%). While the heuristic only requires seconds to compute the partitioning per use case and setting, the integer program requires several hours using the LP solver SoPlex1 on the aforementioned server hardware.

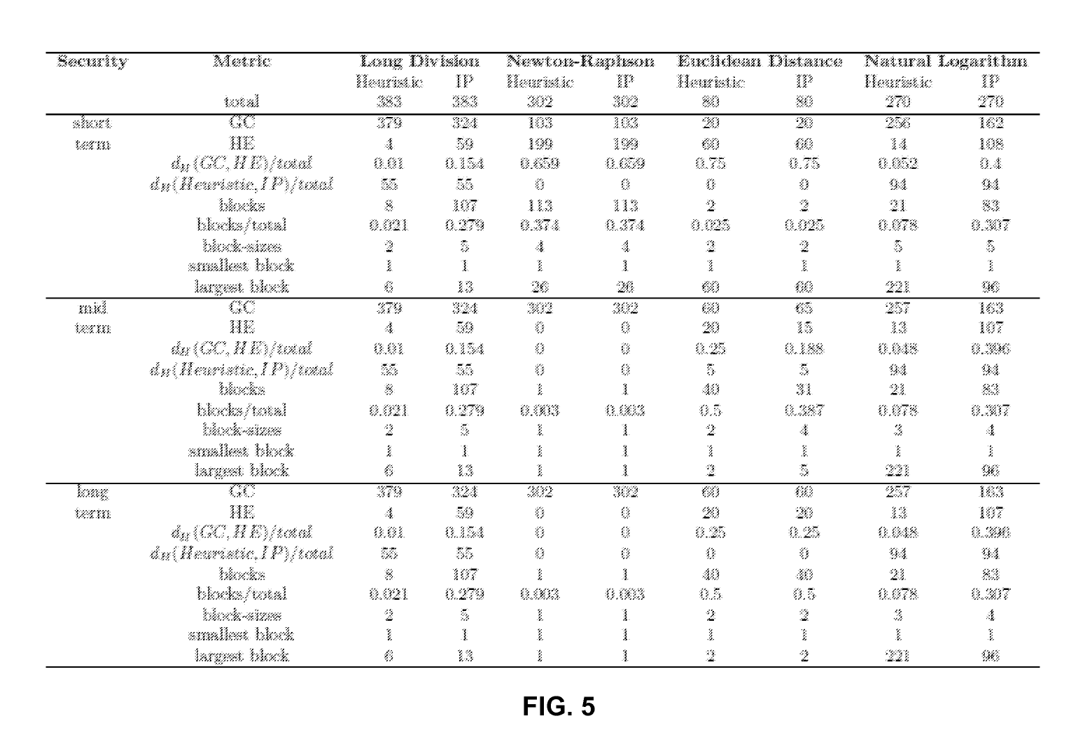

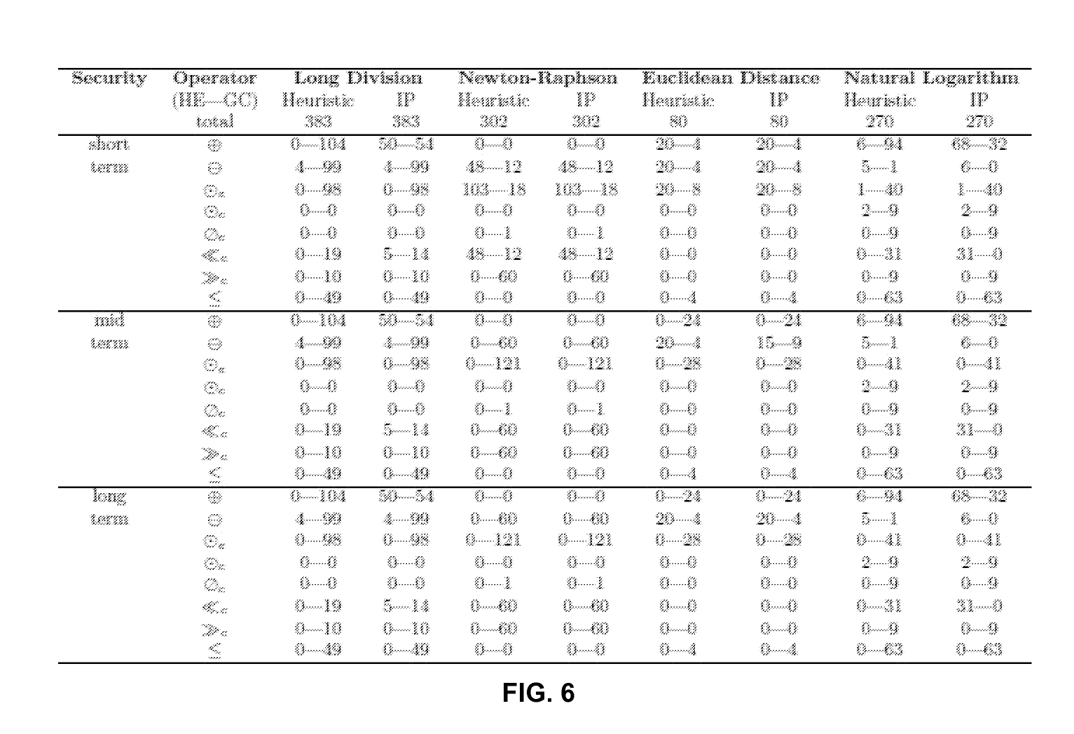

While the performance of the mixed protocols found by the two partitioning algorithms is similar, FIGS. 5-6 show that the resulting partitionings differ in several aspects. In particular, FIG. 5 shows metrics and values of partitionings for a number of algorithms. FIG. 6 shows operators and their protocol assignment by partitioning for a number of algorithms.

The heuristic, in comparison to the integer program, tends to reduce the number of blocks of consecutive operations with the same protocol type. For long division and natural logarithm, over all settings, the ratio between number of blocks and number of operations is less than 0.025, while it is more than 0.279 (i.e., larger by a factor of 10) for the integer program. On the contrary, results for Newton-Raphson and Euclidean distance show that both partitioning algorithms may result in similarly high (0.5) or low (0.003) ratios.

3.4.3 Manual Versus Automated Partitioning

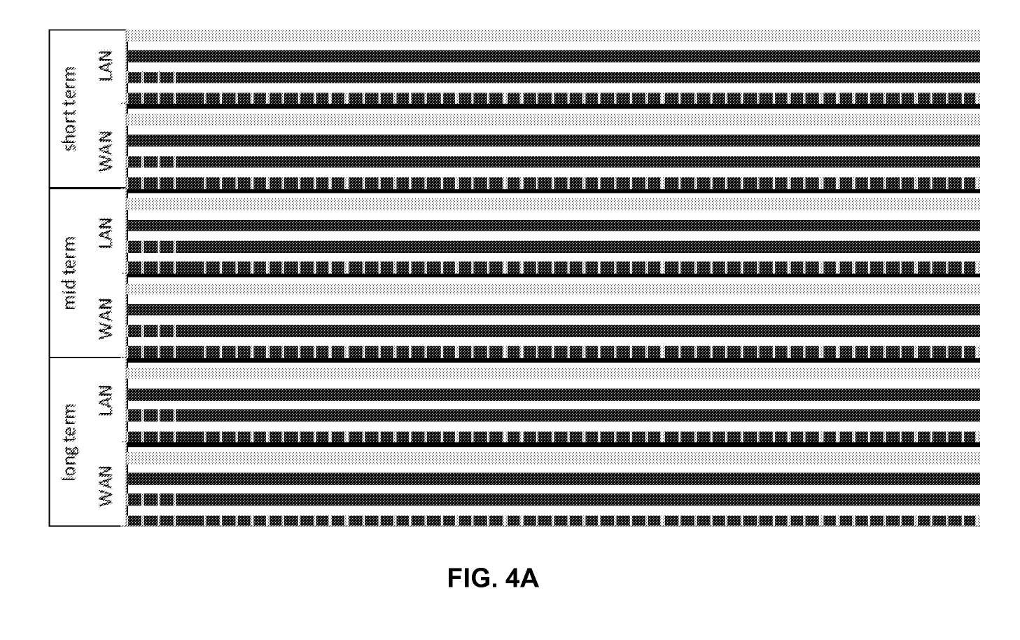

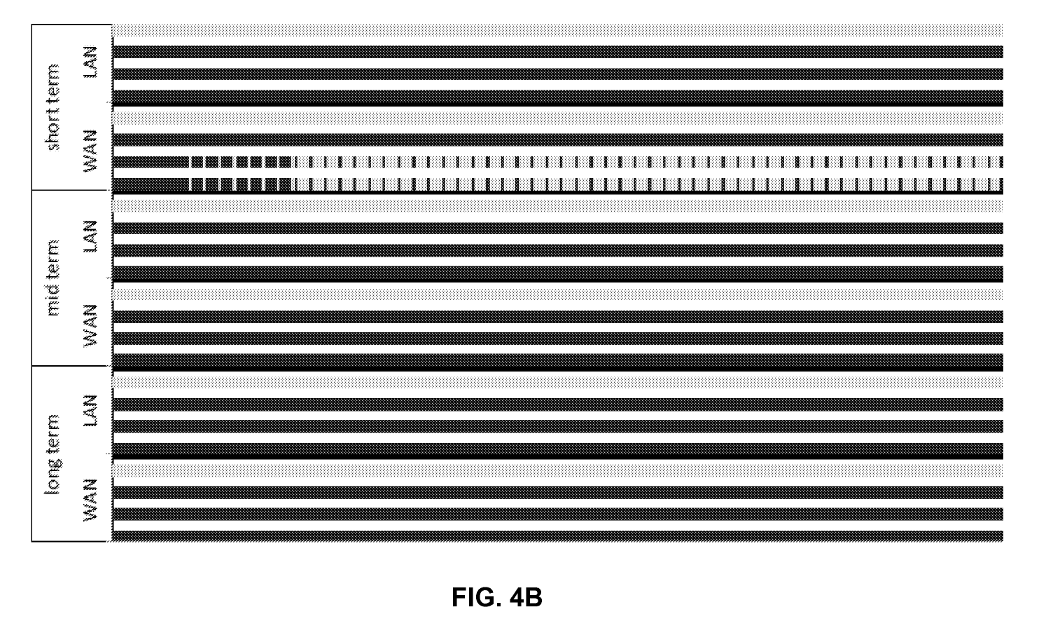

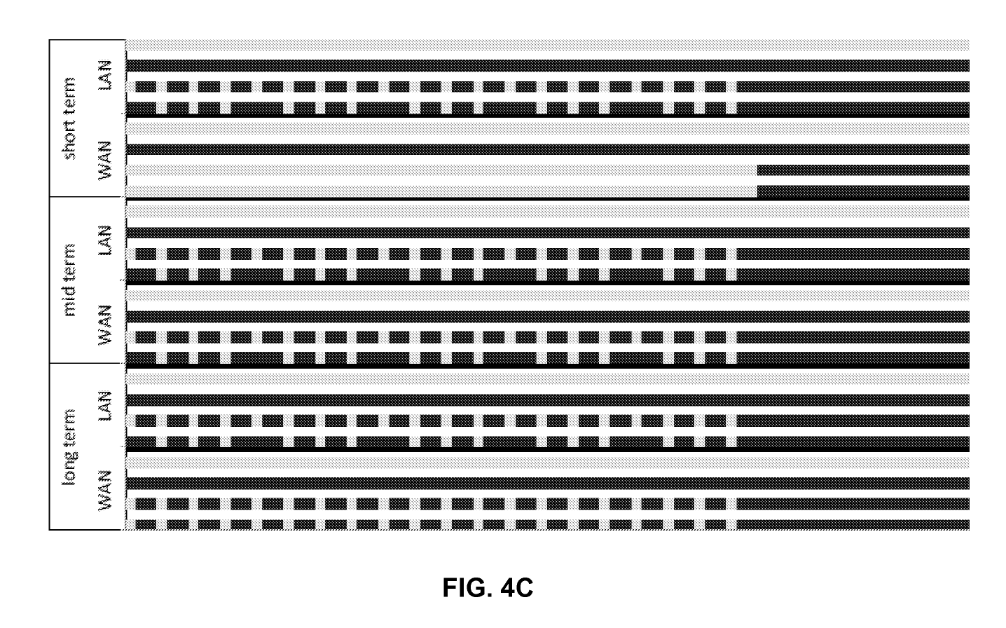

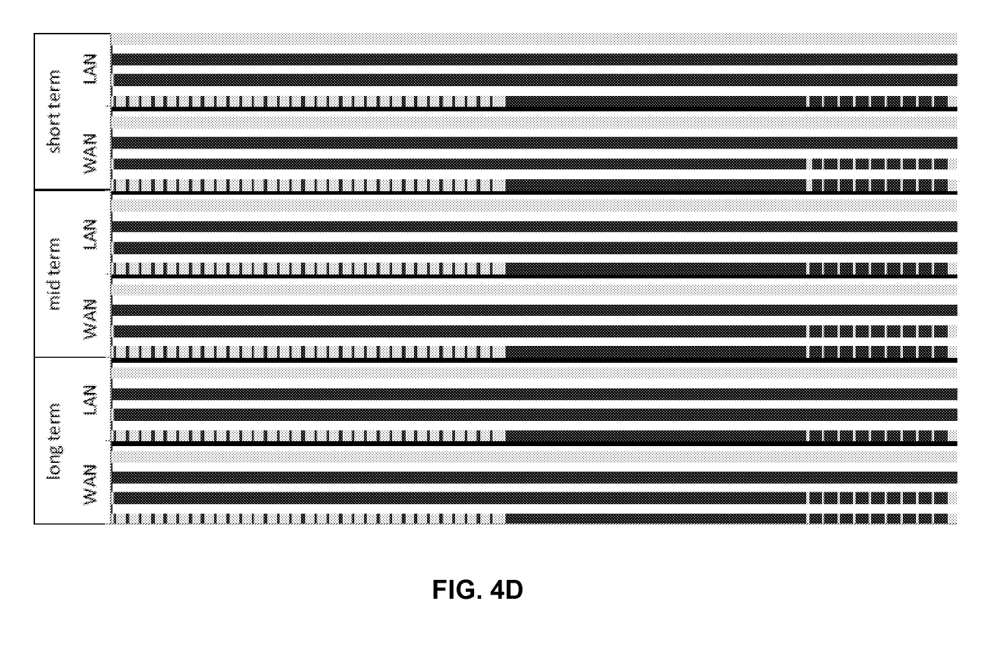

FIGS. 4A-D shows how the optimization approaches partitioned the use cases in the various settings, with 32 bit inputs. FIG. 4A shows the long division use case. FIG. 4B shows the Newton-Raphson use case. FIG. 4C shows the Euclidean distance use case. FIG. 4D shows the natural logarithm use case.

Operations computed using garbled circuits are depicted in solid, those computed using homomorphic encryption in gray. The bars for the partitionings are displayed top-down as HE-only, GC-only, heuristic and integer program.

The diagrams in FIGS. 4A-D and the metrics of FIG. 6 show that the mixed protocols are heavily fragmented in order to achieve the optimal performance results. A wide spectrum of fragmentations is obtained. For Euclidean distance, 40 blocks (of at most two operations per block) are used within only 80 operations in total. Similarly, for Newton-Raphson, 113 blocks (of 1 to 26 operations per block) are obtained within 302 operations. Regarding partitions with at least two blocks, the largest block for natural logarithm (of 221 operations) are obtained within 270 operations.

Although there seem to be patterns in some areas of the diagrams, it is difficult to infer a general conclusion that can be used to manually derive a partitioning with similar performance. FIGS. 4A-D show that for some sub-sequences partitions are constant (within the same network setting but for changing security levels, e.g., long division). Others change within the same network setting for changing security levels (e.g., Euclidean distance and Newton-Raphson). In only 3 out of 12 cases there is no change in the partitioning across different network settings.

Even unrolled operation blocks that are identical on the operation level, result in different partitionings within the same setting and use case. One such example is the natural logarithm; operations that are part of the main loop last from the middle of the algorithm until the (third) last operation.

It is assumed that there would be a rather intuitive relation between single operations in the intermediate language and both types of discussed protocols. Intuitively, for shared values (which is designed to be part of the homomorphic encryption model), operations can be assumed to be fast, if they are executed as local operations that do not use cryptographic algorithms (e.g., addition or multiplication by a constant). Similarly, garbled circuits could be supposed to perform faster than homomorphic encryption for comparing two secret values. FIG. 6 shows the number of operations performed using garbled circuits or homomorphic encryption in the mixed protocols found by the selection algorithms. These metrics show that the relations are rather complex. For Newton-Raphson and short-term security, the integer program assigns 48 of 60 subtraction operations to homomorphic encryption, since these operations can be implemented locally without communication. For the same security setting, the integer program assigns 99 of 103 subtraction operations to garbled circuits. The same conclusion is support by the Euclidean distance use case. For mid-term security, the integer program assigns all 24 addition operations to garbled circuits, while 20 out of 24 subtraction operations (with the same costs as addition) get assigned to homomorphic encryption. This underpins the complexity of the context of adjacent operations and conversions.

In conclusion, presented herein are algorithms for the automatic selection of a protocol—garbled circuits or homomorphic encryption—in secure two-party computation. Based on a performance model the algorithms minimize the costs of a mixed protocol. This evaluation is presented based on three use cases from the literature: secure joint economic lot-size, biometric identification, and data mining

The results support that mixed protocols perform better than pure garbled circuit implementations. In 8 out of 24 experiments a performance gain of 20% on average is achieved. It is concluded that the option to mix protocols improves performance of secure two-party computation.

The results also support that the heuristic is close to the optimization algorithm based on integer programming. In all experiments the heuristic achieved a performance within 2.7% of the optimum on average. Nevertheless, the heuristic runs within seconds whereas the integer program requires hours. To conclude, it is practically feasible to perform the (near-optimal) selection within a compiler.

Furthermore, detailed analysis of the experiments also revealed that there is no discernible pattern of the selection. A programmer cannot rely on simple hints in order to perform the selection of the protocol manually. It is therefore concluded that the protocol selection problem is too complicated to be solved manually by the programmer and needs to be solved automatically, e.g., by a compiler.

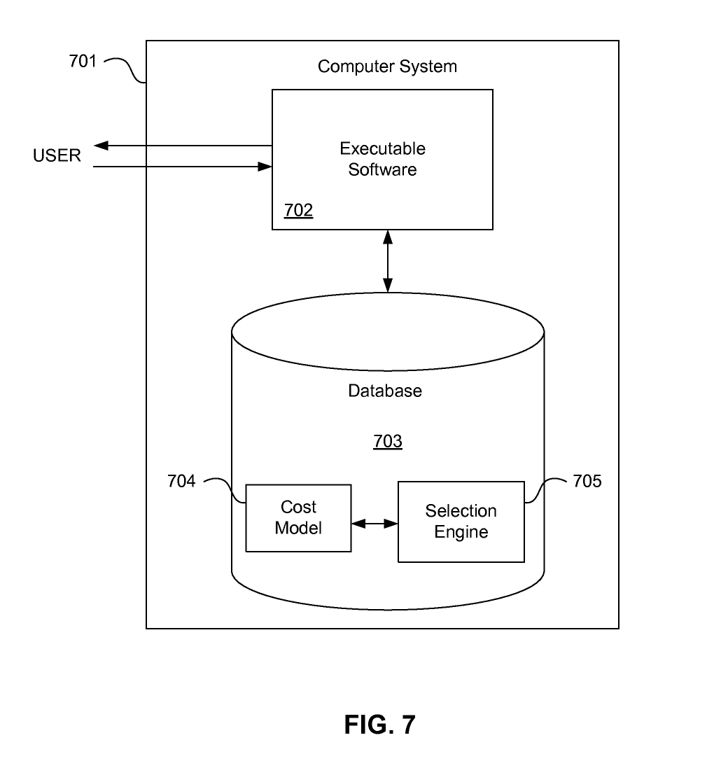

FIG. 7 illustrates hardware of a special purpose computing machine configured to perform automatic protocol selection according to an embodiment. In particular, computer system 700 comprises a processor 702 that is in electronic communication with a non-transitory computer-readable storage medium 703. This computer-readable storage medium has stored thereon code 705 corresponding to a selection engine. Code 704 corresponds to a cost model. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

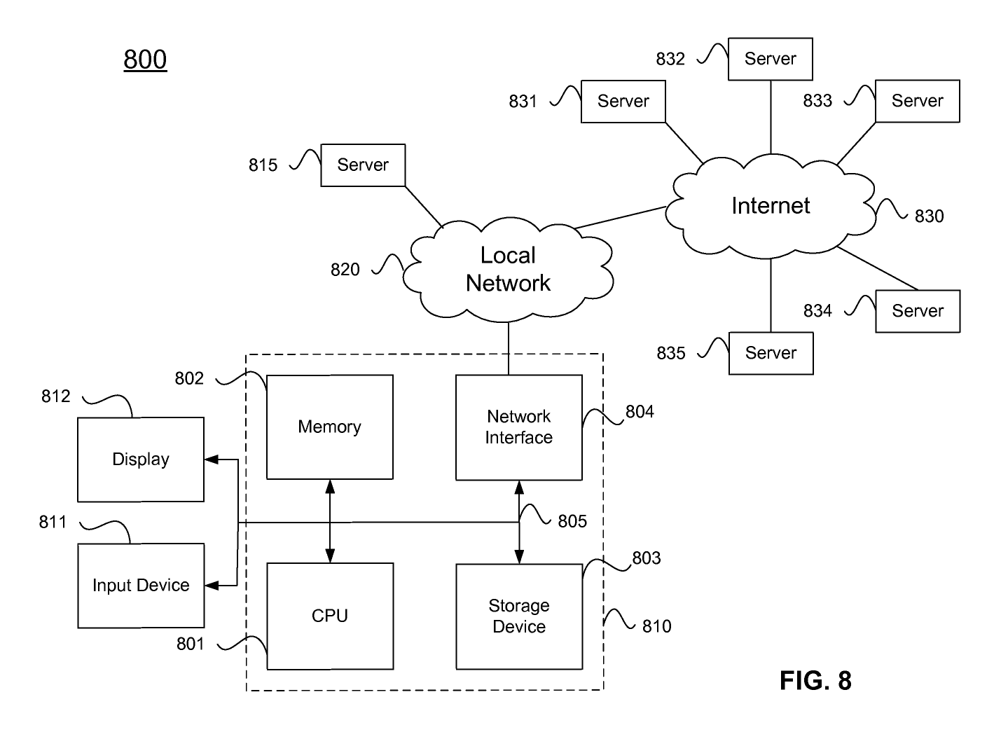

An example computer system 810 is illustrated in FIG. 8. Computer system 810 includes a bus 805 or other communication mechanism for communicating information, and a processor 801 coupled with bus 805 for processing information. Computer system 810 also includes a memory 802 coupled to bus 805 for storing information and instructions to be executed by processor 801, including information and instructions for performing the techniques described above, for example. This memory may also be used for storing variables or other intermediate information during execution of instructions to be executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 803 may include source code, binary code, or software files for performing the techniques above, for example. Storage device and memory are both examples of computer readable mediums.

Computer system 810 may be coupled via bus 805 to a display 812, such as a cathode ray tube (CRT) or liquid crystal display (LCD), for displaying information to a computer user. An input device 811 such as a keyboard and/or mouse is coupled to bus 805 for communicating information and command selections from the user to processor 801. The combination of these components allows the user to communicate with the system. In some systems, bus 805 may be divided into multiple specialized buses.

Computer system 810 also includes a network interface 804 coupled with bus 805. Network interface 804 may provide two-way data communication between computer system 810 and the local network 820. The network interface 804 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 804 sends and receives electrical, electromagnetic, or optical signals that carry digital data streams representing various types of information.

Computer system 810 can send and receive information, including messages or other interface actions, through the network interface 804 across a local network 820, an Intranet, or the Internet 830. For a local network, computer system 810 may communicate with a plurality of other computer machines, such as server 815. Accordingly, computer system 810 and server computer systems represented by server 815 may form a cloud computing network, which may be programmed with processes described herein. In the Internet example, software components or services may reside on multiple different computer systems 810 or servers 831-835 across the network. The processes described above may be implemented on one or more servers, for example. A server 831 may transmit actions or messages from one component, through Internet 830, local network 820, and network interface 804 to a component on computer system 810. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
providing a compiler including a protocol selection engine and a cost model;
causing the protocol selection engine to receive a function description comprising a plurality of operations;
applying an optimization algorithm to calculate from the cost model, a cost of converting an operation to an operation encrypted according to a first protocol or a second protocol;
causing the protocol selection engine to create an encrypted function according to the first protocol or according to the second protocol, depending on the cost.

2. The computer-implemented method of claim 1 further comprising causing the compiler to provide the encrypted function for secure multi-party computation in a semi-honest model.

3. The computer-implemented method of claim 1 wherein the optimization algorithm comprises a heuristic algorithm.

4. The computer-implemented method of claim 1 wherein the optimization algorithm comprises an integer programming algorithm.

5. The computer-implemented method of claim 1 wherein the first protocol comprises a garbled circuits protocol.

6. The computer-implemented method of claim 1 wherein the second protocol comprises a homomorphic encryption protocol.

7. A non-transitory computer readable storage medium embodying a computer program for performing a method, said method comprising:
providing a compiler including a protocol selection engine and a cost model;
causing the protocol selection engine to receive a function description comprising a plurality of operations;
applying an optimization algorithm to calculate from the cost model, a cost of converting an operation to an operation encrypted according to a first protocol or a second protocol;
causing the protocol selection engine to create an encrypted function according to the first protocol or according to the second protocol, depending on the cost.

8. A non-transitory computer readable storage medium as in claim 7 further comprising causing the compiler to provide the encrypted function for secure multi-party computation in a semi-honest model.

9. A non-transitory computer readable storage medium as in claim 7 wherein the optimization algorithm comprises a heuristic algorithm.

10. A non-transitory computer readable storage medium as in claim 7 wherein the optimization algorithm comprises an integer programming algorithm.

11. A non-transitory computer readable storage medium as in claim 7 wherein the first protocol comprises a garbled circuits protocol.

12. A non-transitory computer readable storage medium as in claim 7 wherein the second protocol comprises a homomorphic encryption protocol.

13. A computer system comprising:
one or more processors;
a software program, executable on said computer system, the software program configured to:
provide a compiler including a protocol selection engine and a cost model;
cause the protocol selection engine to receive a function description comprising a plurality of operations;
apply an optimization algorithm to calculate from the cost model, a cost of converting an operation to an operation encrypted according to a first protocol or a second protocol;
cause the protocol selection engine to create an encrypted function according to the first protocol or according to the second protocol, depending on the cost.

14. A computer system as in claim 13 further comprising causing the compiler to provide the encrypted function for secure multi-party computation in a semi-honest model.

15. A computer system as in claim 13 wherein the optimization algorithm comprises a heuristic algorithm.

16. A computer system as in claim 13 wherein the optimization algorithm comprises an integer programming algorithm.

17. A computer system as in claim 13 wherein the first protocol comprises a garbled circuits protocol.

18. A computer system as in claim 13 wherein the second protocol comprises a homomorphic encryption protocol.
